(19) United States
(12) Patent Application Publication
(10) Pub. No.: US 2019/0135327 A1
(43) Pub. Date: May 9, 2019

(54) Frame for steering wheel and manufacturing method therefor

(71) Applicant: ULTRAFLEX S.P.A., Casella (GE) (IT)

(72) Inventors: Andrea Milanese, Busalla (GE) (IT); Marcella Gai, Busalla (GE) (IT)

(21) Appl. No.: 16/128,991

(22) Filed: Sep. 12, 2018

(30) Foreign Application Priority Data
Sep. 13, 2017 (IT) 102017000102641

(51) Int. Cl. B62D 1/08; B62D 1/06; B62D 1/10; B21D 53/30

(52) U.S. Cl. CPC B62D 1/08; B21D 53/30; B62D 1/10; B62D 1/06

(57) ABSTRACT

A frame for a steering wheel is made from a sheet of predetermined thickness that is cut to a desired dimension and shaped bi- or three-dimensionally. A steering wheel produced from such frame includes a coating layer on at least some areas or parts.

### FIELD OF THE INVENTION

The present invention concerns a frame for a steering wheel.

### BACKGROUND OF THE INVENTION

Nowadays, steering wheels are currently obtained by providing a rigid support frame of the steering wheel, which is partially coated in one or more zones or completely with different methods and materials. The frame can be made of different materials adapted to provide the structural rigidity and shape required for a steering wheel, and in more parts, which are produced separately and subsequently combined with one another by mechanical coupling or by chemical/physical coupling. Alternatively, the frame can be obtained in one piece. In case of frames made of plastic and/or metal material, in particular in one piece, methods are used to manufacture the frame itself, typically molding by injection molding when using plastic materials and/or by die-casting when using metal materials or similar. Typically, a steering wheel comprises three members, a peripheral outer ring, which constitutes a handle member for the hands of the user, a flange for directly or indirectly fastening to a steering control shaft around which the steering wheel rotates and whose fastening flange is provided inside the peripheral ring, and one or more connecting arms of the outer ring of the fastening flange, which are arranged angularly along the extension of the outer ring and the fastening flange.

In the state of the art, there are also variants in which the outer ring is not continuous, but is only constituted of two annular segments substantially diametrically opposite one another and which end with the facing ends at a certain distance from one another, the part of outer ring interposed between the two annular segments being lacking.

Constructive variants, whose application is particularly provided in the nautical field, can also provide the complete lack of the outer ring, such as, for example, in the helm wheels of boats.

In the construction of steering wheels or similar, different contrasting aspects must be optimized, therefore forcing to adapt the structure and manufacturing methods.

On the one hand, the steering wheel being also a supporting member for the user, which the user grasps to maintain the balance, such as, for example, in the case of boats, the steering wheel structure must be so that to withstand mechanical stresses going beyond those necessary for exerting the steering control function only. On the other hand, the steering wheel must not be excessively heavy. Moreover, the costs of the materials and manufacturing must be limited.

At the same time, both the structure and manufacturing method must allow a wide possibility of variation to satisfy the aesthetic and shape requirements, and also to allow additional steering functions to be coupled to the steering wheel.

### SUMMARY OF THE INVENTION

According to a first aspect, the invention aims to obtain a supporting frame for a steering wheel, capable of satisfying the requirement to confer optimal mechanical resistance to the structure, by using a material that ensures a limited weight and that allows the use of a quick and inexpensive manufacturing method, without however compromising the possibility of achieving aesthetic variations and of integrating control accessories.

According to a further aspect, the invention aims to obtain a steering wheel comprising said frame capable of satisfying the aforesaid requirements.

According to a third aspect, the invention aims to provide a manufacturing method of a steering wheel frame that is inexpensive and that allows to obtain a very robust and relatively low-weight frame, whose appearance can be easily modified and to which control accessories can be added.

According to a further aspect, the invention aims to provide an inexpensive manufacturing method of a steering wheel that is inexpensive, that has a high structural resistance, that is relatively low-weight, whose appearance can be easily modified and to which control accessories can be added.

With reference to the first aspect, the invention aim to obtain a steering wheel frame made of a sheet of a predetermined width, cut to size and bi-dimensionally or three-dimensionally shaped.

According to an embodiment, the sheet is molded and cut so that to constitute at least one central plate-shaped member and/or at least one segment of arched member connected to one another by at least one arm.

In an embodiment, the at least one arched member defines at least one radius of curvature thereof and one axis passing through the origin of said radius, said arm being oriented with its longitudinal axis substantially radial to said axis.

In an embodiment variant, said arm is oriented with its longitudinal axis tangent to a point of a closed annular line that develops around said axis passing through said radius of curvature of said arched member.

A preferred embodiment provides at least one couple of arched segments arranged symmetrically with respect to a plane of symmetry and whose arched segments are each connected, by means of at least one arm, to opposite points with respect to said plane of symmetry of a central fastening plate.

A further embodiment variant provides that, in place of two arched members, the frame has an annular member closed on itself and connected to a fastening plate arranged inside of the area delimited by the annular member, said fastening plate and said annular member being connected to one another by means of at least one arm and two or more arms arranged angularly with respect to the extension of the annular member and the fastening plate.

An embodiment provides that said steering wheel frame has a rotational symmetry as for the arched members or single annular member and/or the fastening plate and/or the connecting arms of the fastening plate are concerned with respect to the annular member or the arched segment or segments.

Advantageously, with reference to this embodiment, the rotational symmetry axis of the frame coincides with the rotation axis of the steering wheel.

An embodiment variant provides that the frame only comprises a fastening plate from which at least one or preferably more arms, arranged angularly and preferably angularly equidistant from one another, extend.

Still according to an embodiment, the frame is made of a plate with a thickness between 0.3 and 1 cm, preferably between 0.4 and 0.6 cm.

Different materials can be used, preferably metals and, in particular, steel or aluminum.

Still according to an embodiment variant, the frame according to one or more of the preceding variants is in one piece, the arched member and/or arched members and/or the arm(s) and/or the fastening plate being in one piece.

An embodiment variant provides that the annular arched member or annular arched members or the annular member have a cross-sectional arch in a plane perpendicular to the plane subtended by said members, i.e. containing said members, in particular, said cross-sectional arch is oriented with the concave side facing the zone intended to constitute the back side of the steering wheel.

A further embodiment variant provides that the fastening plate is provided with at least one, preferably two, holes or a crown of holes for fastening to an end hub of the steering shaft or directly to a steering shaft.

Still a further embodiment provides that the fastening plate is provided with a plane axially spaced from the plane subtended by the arched member(s) or the annular member, with reference to an axis perpendicular to said plane, while the arms extend between said two planes.

An embodiment provides that the steering wheel has a cross-sectional concave shape in a plane perpendicular to the plane subtended by the arched member and/or arched members or annular member.

Said concave shape can be similar to a bowl- or soup plate-like shape.

According to the second aspect of the invention, said frame is provided in combination with at least one partial outer coating, which completes the shape of the frame in accordance with the shape provided for a finished steering wheel.

The coating can be at least partly made of plastic material and/or at least partly of natural material and/or at least partly of metal material.

The coating part made of plastic material can be applied by mechanical fastening or by chemical/physical adhesion, such as gluing or overmolding.

Different types of plastic materials can be provided, in particular thermoplastic polymers, such as polyurethanes or similar.

The coating part made of natural materials can provide, for example, coatings made of leather and/or wood to the frame by chemical and physical adhesion or by mechanical fastening.

The coating part made of metal material can consist of inserts and/or zones laminated with different types of metals and/or with different surface machining, which are applied to the frame by mechanical means and/or by welding and/or gluing.

The different coating parts can also overlap one another, at least in some zones.

Some zones of the frame can be left uncoated, such as, for example, the zone of the fastening plate and/or part of the arms connecting the fastening plate to the arched member(s) and/or annular member.

The invention therefore concerns a steering wheel providing a supporting frame part and one or more coating parts for all or only for some parts or zones of the supporting frame with one or more different materials and wherein the supporting frame is made according to one or more of the aforesaid embodiments in combination with one or more of the variants relative to the materials constituting the outer coating of the supporting frame and/or to the application zones of the supporting frame with respect to these coating materials.

The invention also concerns a method of manufacturing a supporting frame of a steering wheel or similar, the method comprising the following steps:

(a) cutting to size, from a sheet of rigid material, a member having at least one ed perimeter shape of the frame;

(b) bi-dimensionally or three-dimensionally molding the member cut to size in point (a).

According to an embodiment, in addition to cutting to size the member with the perimeter shape corresponding to the final perimeter shape of the frame, one or more steps (c) are provided and can be carried out in sequence or during the cutting of the parts of the material of the sheet to make through-openings, for example relative to the engagement holes of the fastening members of the fastening plate to a shaft and/or to a hub and/or to make slots laterally delimiting one or two connecting arms between the fastening plate and one or more arched members or annular member and/or to delimit inside the inner edge of the arched member(s) or annular member and the facing peripheral edge of the fastening plate.

The aforesaid steps (a) and (b) and the steps for cutting slots and/or openings and/or through-holes in the member can be carried out in one single molding step by molding the sheet of material.

Step (a) can provide the cutting of members in the shape of a flat disk, whereas step b can be combined with the step or steps (c) carried out on the circular member.

The material of the sheet can consists of any material having a rigidity suitable for the mechanical stresses to which the steering wheel is subjected and can be a homogeneous material, or the sheet is constituted of a composite material, such as a two-layer or multilayer material.

Preferably, said material can be formed bi- or three-dimensionally by molding.

The invention also concerns a steering wheel manufacturing method comprising a frame according to one or more of the preceding embodiments and the method provides the following steps:

providing a frame according to one of the aforesaid embodiment variants;

applying, on at least some zones of said frame, an outer coating of at least one material, different materials being applied one on top of the other in at least some coinciding zones or, alternatively, between one another in different zones among them.

According to an embodiment variant, a coating material consists of a coating of plastic material, said coating being applied on the entire frame or on one or more different zones space from one another by overmolding.

Alternatively or in combination, at least one further coating material can consists of a material of animal, plant or metal origin.

Still according to an embodiment, in at least some zones of the frame, at least one coating material is applied by chemical/physical adhesion.

Still according to an embodiment, in at least some zones, at least one coating material is applied by means of a mechanical connection.

According to the above, the advantages of the structure of the steering wheel frame are clear, which constitutes an intermediate product preparatory for the manufacturing of steering wheels having an improved mechanical resistance ratio in terms of structure, external stresses, weight, production cost and flexibility of generating different aesthetic forms.

### BRIEF DESCRIPTION OF THE DRAWINGS

These and other characteristics and advantages of the present invention will become clearer from the following description of some examples of embodiments shown in the accompanying drawings, in which:

FIGS. 1 to 3 respectively show a perspective view of the front side, a side view and a plan view of a front side of the steering wheel frame according to the present invention.

FIGS. 4 and 5 show a plan view of a steering wheel provided with a frame according to the present invention, wherein a sectional plan of the sectional view of FIG. 5 is drawn.

FIGS. 6 to 8 respectively show a perspective view, a side view and a plan view, similar to FIGS. 1 and 3, of a steering wheel according to a first embodiment variant.

FIGS. 9 to 11 respectively show a perspective view, a side view and a plan view, similar to FIGS. 1 and 3, of a steering wheel according to a further embodiment variant.

FIG. 12 shows a perspective view of a steering wheel according to a further embodiment.

### DETAILED DESCRIPTION OF EMBODIMENTS OF THE INVENTION

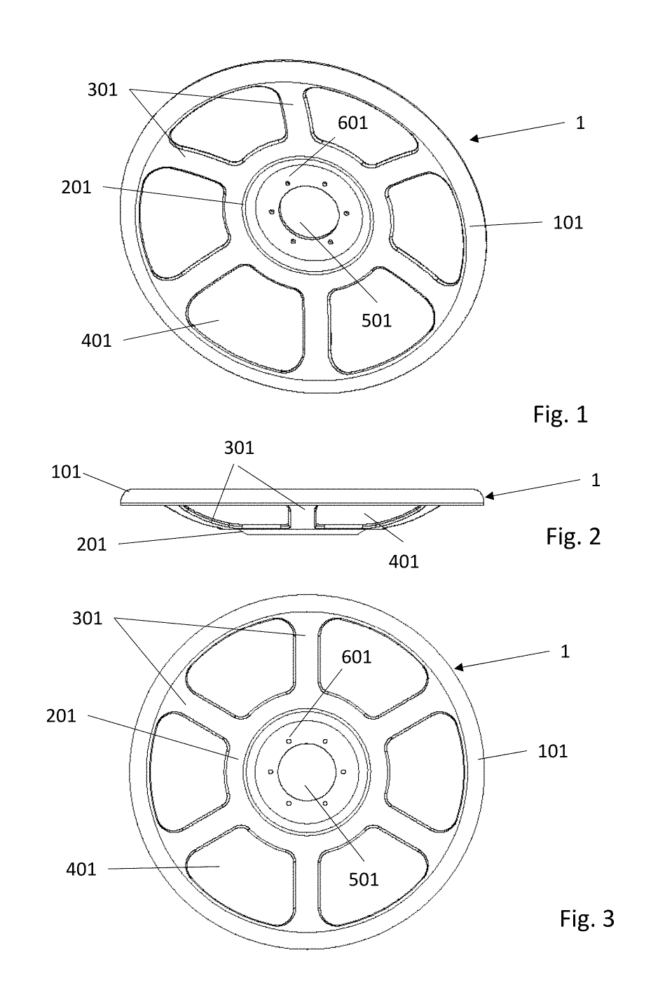

FIGS. 1 to 3 show a frame member 1 or core of a steering wheel structure, the member being made of a rigid material and constituting the supporting frame of the steering wheel.

The frame 1 shown is relative to a specific embodiment that is not to be considered limiting of the inventive concept since different variants, described with reference to the differences compared to the embodiment shown, can be provided.

Specifically, the embodiment shown of the frame 1 provides that it has a rotational symmetry with respect to an axis intended, in the specific case, to be coinciding with the rotation axis of the steering wheel when mounted on a steering shaft, not shown.

An annular member 101 is provided coaxially and a central annular fastening plate 201 is connected thereto by means of a plurality of radial arms 301 arranged along the circumference so that to be angularly equidistant from one another.

The arms join on one end that widens with a rounded pattern to the annular member 101 and delimit, together with the radially outer peripheral edge of the fastening plate 210 and with the radially inner peripheral edge of the annular member 101, a plurality of slots 401.

The fastening plate 201 is provided with a series of holes 601 arranged along a coaxial circular line. The holes 601 can be used for the passage of plugs, screws or bolts for fastening the plate 201 to a hub or terminal of a steering shaft or also to at least partly constitute engagement passages of a coating material that is, for example, overmolded at the central plate 201 and that penetrates in some of said holes 601.

In the embodiment shown, the fastening plate 201 is ring-shaped and delimits a circular central hole 501.

The fastening plate 201 and the annular member 101 are provided axially spaced from one another and the connecting arms 301 of these parts extend tilted between the two planes coinciding with the fastening plate 210 and with the annular member 101, thus conferring a concave envelope shape to the frame on the side facing the front side of the steering wheel and correspondingly convex on the back side.

Different variants can be provided with respect to the embodiment shown.

According to a first variant, a lesser number of radial arms 301 can be provided, such as, for example, only two radial arms or also only one radial arm 301. In these cases, the arms can be bigger in size and shape so that to ensure sufficient stability of shape and resistance to mechanical stress on the steering wheel.

According to a further embodiment, the annular member 101 can be open or can be constituted by only two segments diametrically opposite and spaced from one another at their ends by segments of missing ring segments.

Each annular segment can have a non-circular shape and the two segments can only be symmetrical with respect to a plane of symmetry.

The two annular or arched segments can connect to the fastening plate 201 by means of one or more radial arms 301 for each segment.

A further embodiment variant, which can be provided in combination with any of the afore described variants, provides that the fastening plate is not circular.

According to a further variant, which can be provided in combination with any of the preceding embodiment variants, provides that the fastening plate is shaped so that to be eccentric with respect to the annular member 101 or annular or arched segments.

A further embodiment variant therefore provides that the shape of the frame is not rotationally symmetric, but only symmetric with reference to a plane of symmetry, said plane of symmetry coinciding with the rotation axis of the steering wheel.

With reference to a further variant, the arms can have a radial pattern or a tangential pattern or secant to the fastening plate 201.

Still an embodiment variant can provide that the frame is devoid of the annular member 101 or the annular or arched segments, being made only of a fastening plate 201 and arms protruding therefrom and shaped like the spokes of a helm wheel.

The frame, according to the different embodiment variants, is made of a sheet of material, for example metal having a thickness between 0.3 and 1 cm, preferably between 0.4 and 0.6 cm.

The preferred material is metal, such as aluminum or steel for example. However composite materials may also be used, such as sheets of multilayer plastic material, to make the frame 1.

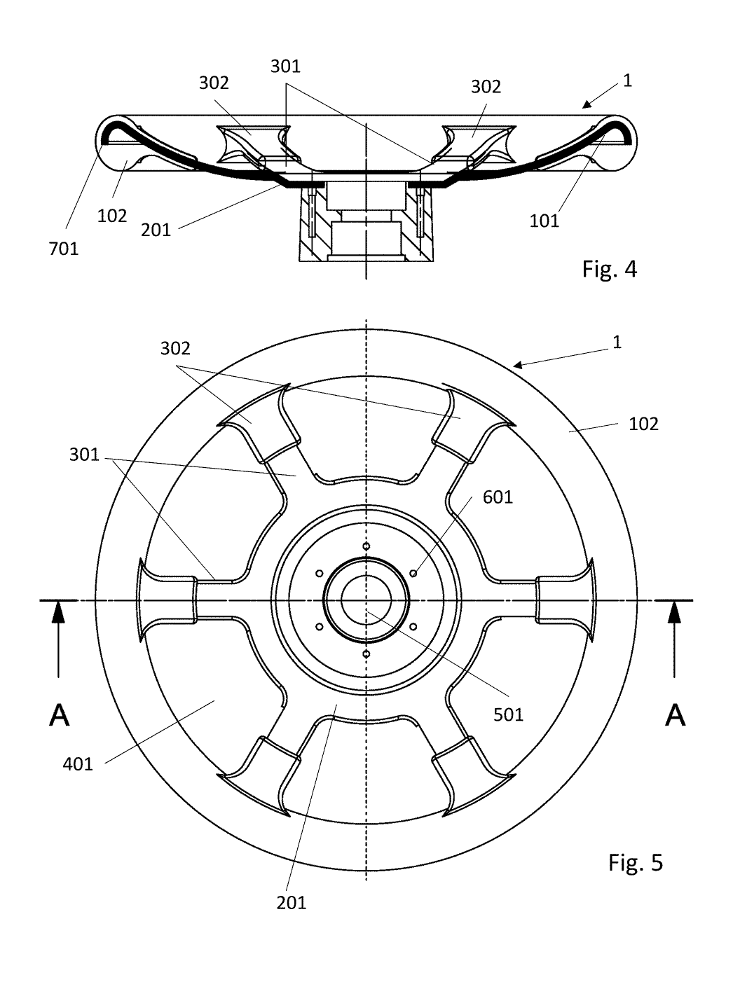

In FIGS. 4 and 5, the embodiment of the frame 1 coated with a finishing material to obtain the final structure of the steering wheel is shown.

FIG. 4, which is a cross-section of the steering wheel 2 and the frame 1, shows an embodiment of the frame, wherein the annular member 101 has, sectionally according to a plane perpendicular to the plane subtended by the annular member itself 101 and the sectional plane is denoted by A-A in FIG. 5, the plane subtended by the annular member being parallel to the plane of the sheet, an arched shape with the concavity facing and opened towards the back side of the annular member with reference to the position that the frame assumes when mounted and implemented on the steering wheel 2.

The cavity coincides with a convex surface of said annular member 101 provided facing the front side of the implemented steering wheel 2, i.e. mounted for use.

According to a further characteristic, the rounded sectional shape ends along the radially more outer side of the annular member with an annular wall 701 that ends facing a direction substantially perpendicular to the plane subtended by the annular member 101.

As is clear in the embodiment shown, the frame 101 is coated at least on some parts with an outer coating, especially overmolded of plastic material and denoted by 102.

In the embodiment shown, the outer coating also extends also for part of the arms 301, as denoted by 302 and, in particular, along an end part at the end joining to the annular member 101.

In this embodiment, the remaining part of the arms and the central fastening plate 201 are instead devoid of any coating and the frame is therefore exposed.

FIG. 4 also shows an example of how the fastening plate 201 is connected to a rotary-coupling hub 3 with a shaft of a steering mechanism not shown. Bolts 103 are screwed in threaded holes of the hub through one or more holes or all holes 601 of the crown of holes obtained on the fastening plate 201.

According to an embodiment variant, which can be provided in combination with any embodiments and variants described for the frame 1, the annular member 101 and/or arms can have through-openings through which the coating material 102, 302 passes, constituting bridges of material that mechanically constrain the coating 102, 302 to the frame.

The arched shape of the annular member 101 also helps generate a mechanical shape coupling with the coating 102, which reinforces the chemical and physical adhesion of the coating 102 to the material of the frame.

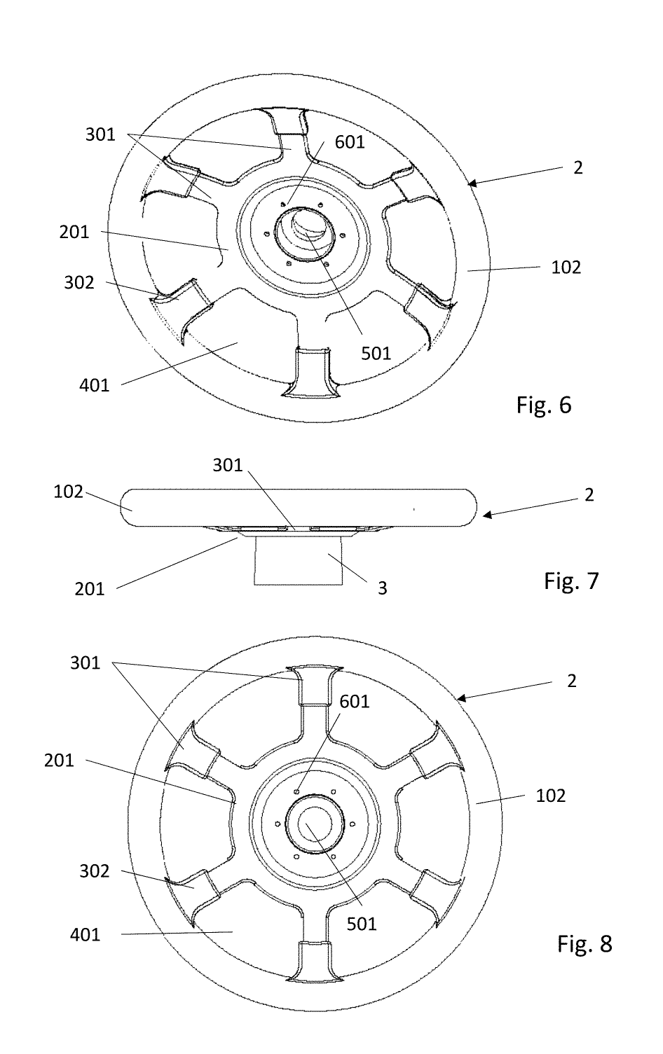

The embodiment a of the FIGS. 4 and 5 is further shown in FIGS. 6 to 7.

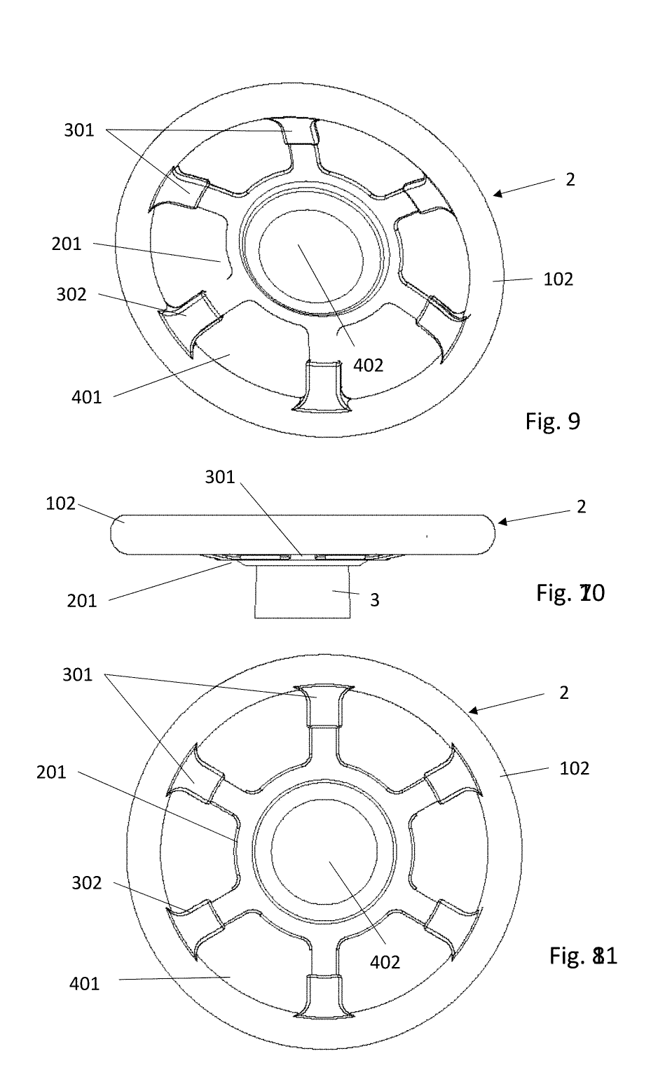

FIGS. 9 to 11 show a further embodiment, wherein the zone of the fastening plate 201 is coated along a central part of smaller diameter than the maximum diameter of the fastening plate 201 with a coating member 402. This coating member can be applied by chemical/physical adhesion, by gluing for example, by means of fastening with an elastic joint provided with teeth, which engage and snap fit into the seats obtained in the fastening plate, or with a coaxially threaded male or female member, which engages in a corresponding concentric threaded member fastened or shaped in one piece with the fastening plate.

The field technician may resort to the other methods available to him for fastening said coating 402.

In the embodiment of FIGS. 9 to 11, the coating member leaves a peripheral annular strip of the fastening plate 201 of the frame uncovered.

Other embodiment variants are possible and wherein said coating member 402 is not concentric with the fastening plate 201 and/or with the annular member 101, and wherein it also may have a non-rounded or non-circular shape.

Still with reference to FIG. 4, according to a particular embodiment, the curvature of the cross-sectional shape, shaped like an inverted channel, of the annular member 101 is substantially coaxial to the curvature of the sectional shape of the coating 102.

In relation to the coating 102, 302 and 402, different variants are possible.

According to a first variant, the coating 102 of the annular member and/or 302 of the arms and/or 402 of the fastening plate can be composite.

An embodiment provides, for example, that said coating is made by at least two layers, for example one or more inner layers of a plastic material and one outer finishing layer of another plastic material.

Different types of plastic materials can be used. In the embodiment with more layers, at least one coating layer adhering to the frame and one coating layer whose function is to make the steering wheel more acceptable to the touch and grip, can be provided.

A more inner layer of a more rigid material, which cooperates with the frame, and an outer layer, which at least partly covers said inner layer and which is a soft material, such as a foamed plastic or plastic foam for example, can be provided.

A variant can provide a coating layer of expanded material that is adjacent to the surface of the frame member for at least some zones thereof and which is externally coated by a layer of harder plastic material, which confers rigidity to the coating, while the expanded and more inner layer constitutes an open or closed cell filling volume that makes the coating lighter.

According to an embodiment, different zones or parts of the frame can be coated with materials or combinations of different materials.

According to a further embodiment, at least some zones of the frame 1 can be coated with natural materials, such as leather or wood, or with a metal different from the material the frame is made of.

These materials can constitute a single layer coating for at least some zones or can constitute an outer finishing layer for at least some zones of one more inner coating layer of the frame.

These materials can also be fastened by chemical/physical adhesion and/or mechanical fastening.

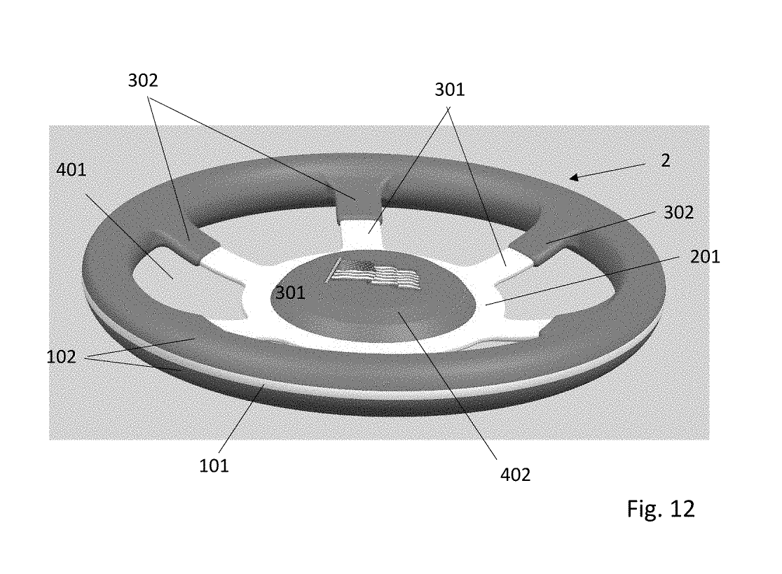

FIG. 12 shows an embodiment variant, wherein the annular member 101 is made in the shape of a flat ring and is only coated on the outside at the two opposite faces, while at least the radially outer peripheral edge remains exposed. In this case, it is advantageous to provide through-slots for the coating material of the ring 101 to make the coupling between the coating 102 and the annular member 101 of the frame more stable.

With reference to the manufacturing method, the frame 1 according to one or more of the preceding claims can be obtained from a sheet of material cut to size and with a plan shape substantially corresponding to the final shape of the frame 1 or anyhow correlated to the final shape of the frame, the cut to size sheet being subjected to a bi-dimensional or three-dimensional forming method by molding.

The holes and slots 401, 601 and 501 can be obtained in a subsequent step, before the forming or simultaneously with the forming step by molding.

The method is applied both when the sheet of material is constituted by a piece shaped like a metal sheet, in particular aluminum or steel, and when the sheet is of a single or multilayer composite material that can be formed by means of molding and optionally by heating the sheet, such as, for example, the sheets of various combinations and/or layers of thermoplastic materials or sheets that combine thermoplastic materials or materials of natural fibers and/or mineral fibers and/or metal fibers or reticular structures of thermoplastic materials and/or minerals and/or materials of plant origin and/or metal materials with one another.

Depending on the type of coating, the application method of the coating layer 102, 302 and/or 402 can be carried out according to different methods. When dealing with a coating of plastic materials, whether single layer or multilayer, the frame can be coated also only in certain zones by injection molding the coating material(s) on the frame.

To apply other types of coatings, such as materials of plant origin, for example wood or fabrics or materials of animal origin, such as leather, or metals, the coating is carried out by wrapping or enveloping, for example by gluing and/or fastening with mechanical members.

Advantageously, according to a variant of the manufacturing method of the frame, the cut to size sheet is constituted of a flat disk of material that can be formed by molding and subjected to forming and cutting by molding.

The invention claimed is:

1. A frame for a steering wheel comprising:
a sheet of predetermined thickness that is cut to size and shaped bi- or three-dimensionally.

2. The frame according to claim 1, wherein the frame is obtained from a sheet with a thickness between 0.3 and 1 cm.

3. The frame according to claim 1, wherein the sheet is shaped and cut so that to constitute at least one central plate-shaped member (201) or at least one segment of arched member (101) connected to one another by at least one arm (301).

4. The frame according to claim 3, wherein the at least one arched member (101) defines at least one radius of curvature thereof and one axis passing through the origin of said radius, said arm (301) being oriented with its longitudinal axis substantially radially to said axis.

5. The frame according to claim 4, wherein said arm (301) is oriented with its longitudinal axis tangent to a point of a closed annular line that develops around said axis passing through said radius of curvature of said arched member (101).

6. The frame according to claim 3, further comprising at least one couple of arched segments (101) arranged symmetrically with respect to a plane of symmetry and whose arched segments (101) are each connected, by means of at least one arm (301), to opposite points with respect to said plane of symmetry of a central fastening plate (201).

7. The frame according to claim 6, wherein in place of two arched members, the frame has an annular member closed on itself (101) and connected to a fastening plate (201) arranged inside of the area delimited by the annular member (101), said fastening plate (201) and said annular member (101) being connected to one another by means of at least one arm and two or more arms (301) arranged angularly with respect to the extension of the annular member (101) and the fastening plate (201).

8. The frame according to claim 6, wherein the frame has a rotational symmetry as far as the arched members or single annular member (101) or the fastening plate (201) or the connecting arms (301) of the fastening plate (201) are concerned with respect to the annular member (101) or the arched segment or segments.

9. The frame according to claim 8, wherein the rotational symmetry axis of the frame coincides with the rotation axis of the steering wheel.

10. The frame according to claim 6, further comprising only a fastening plate (201) from which at least one, preferably several arms (301) arranged angularly, extend.

11. The frame according to claim 6, wherein the annular arched member or annular arched members or the annular member (101) have a cross-sectional arch in a plane perpendicular to the plane subtended by said members, i.e. containing said members, causing said arch of the sectional shape to be oriented with the concave side towards the zone intended to form the back side of the steering wheel.

12. The frame according to claim 6, wherein the fastening plate is provided with at least one hole or crown of holes for fastening to an end hub of the steering shaft or directly to a steering shaft.

13. The frame according to claim 6, wherein the fastening plate (201) is provided with a plane axially spaced from the plane subtended by the arched member(s) or the annular member (101), with reference to an axis perpendicular to said plane, while the arms (301) extend between said two planes.

14. The frame according to claim 13, wherein the frame has a cross-sectional concave shape in a plane perpendicular to the plane subtended by the arched member and/or arched members or annular member.

15. The frame according to claim 1, further comprising:
a peripheral handle member connected, by means of at least one arm, to a fastening plate and to a steering shaft, so that the frame can operate like a steering wheel; and
one or more coating parts (102, 302, 402) of all or only of some parts or zones of the frame (1) with one or more different materials.

16. A manufacturing method of a supporting frame for a steering wheel or similar, according to claim 1, comprising:
(a) cutting to size, from a sheet of rigid material having at least one end perimeter shape of the frame; and
(b) bi-dimensionally or three-dimensionally molding the member cut to size in point (a).

17. The method according to claim 16, further comprising one or more steps (c), which can be carried out in sequence or together, of cutting to size parts of the material of the sheet to make through-openings (401, 501, 601) relative to the engagement holes of the fastening members of the fastening plate to a shaft or hub or to make slots laterally delimiting one or two connecting arms between the fastening plate and one or more arched members or annular member or to delimit inside the inner edge of the arched member(s) or annular member and the facing peripheral edge of the fastening plate.

18. The method according to claim 17, wherein the steps (a), (b) and (c) are carried out in one forming step by molding the sheet of material.

19. The method for manufacturing a steering wheel according to claim 16, further comprising:
applying, on at least some zones of said frame (1), an outer coating (102, 320, 420) of at least one material, different materials being applied one on top of the other in at least some coinciding zones or, alternatively, in adjacent zones or different from one another.

20. The method according to claim 19, wherein a coating material consists of a coating of plastic material, said coating being applied on the entire frame or on one or more different zones spaced from one another by overmolding.
